(19) United States
(12) Patent Application Publication
(10) Pub. No.: US 2005/0016357 A1
(43) Pub. Date: Jan. 27, 2005

(54) Drum tuning system

(76) Inventor: Mario Punchard, Marina del Rey, CA (US)

Correspondence Address: Mario Punchard, Unit # 205, 13910 Old Harbor Ln, Marina del Rey, CA, 90292, US

(21) Appl. No.: 10/624,409

(22) Filed: Jul. 21, 2003

(51) Int. Cl. G10D 1/00; G10D 13/02

(52) U.S. Cl. 84/411 R; 84/1

(57) ABSTRACT

The drum tuning system is comprised of a drum ring and a toggle clamp that clamps onto “hooks” that are on the sides of the drum ring. The drum tuning system is operated by clamping the toggle clamp onto each “hook” on the system's ring, clamping down on each “hook”, lifting up the handle on the toggle clamp, which in turns loosens the hook on the toggle clamp and allows the drummer to adjust the length of the toggle clamp's hook to achieve the desired tension required for proper tone on the drum. If further adjustment is required, the drummer merely clamps down on each “hook” on the drum's ring, and repeats the tuning process until the desired tone has been achieved.

### BACKGROUND OF THE INVENTION

In the field of music, the skins on drums are tightened to tune them after they have been played for an extensive period of time or right before a performance. The process whereby drums are tuned has been traditionally a very tedious, time-consuming, and physically uncomfortable process ultilizing screws that are inserted into holes on a ring around the sides of the drums and turned by hand with a tool. This process can take up to ten minutes per screw and is very uncomfortable, tedious, and time-consuming due to the small amount of space available for someone to maneuver their hands while they are tightening each screw. An additional issue with current drum tightening systems and designs is that most drummers do not carry a toolbox with them as standard equipment. Therefore, they usually show up for a performance without the tool they need for tightening the screws on the drum and have to search for a proper tool (sometimes right before an important performance).

Current drum tightening systems also are comprised of a very thick ring that goes around the side of the drum and holds the skin down. The thickness of the ring in also contributes to the time-consuming, tedious, and uncomfortable process of tuning drums. In addition, the thick ring on the drum also makes playing drums uncomfortable since the drummer's hand will hit against the ring while he is playing.

The drum tuning system described in this patent application will virtually eliminate not only the time-consuming process of tuning drums but will also eliminate the discomfort a drummer experiences while playing during a performance. First of all, the drum tuning system is a two-part system comprised of a ring and a toggle clamp. The ring in the drum tuning system is significantly lighter and thinner than those in prior art. This thinner ring sits lower over the skin of the drum, which results in the drummer having virtually no contact with it while they are playing during a performance as well as making the drum tuning process less awkward, The toggle clamp portion of the system works in conjunction with the ring to tune the drum. The drummer merely clamps the toggle clamp onto each “hook” on the ring, clamps down on each “hook”, lifts up the handle on the toggle clamp which in turns loosens the hook on the toggle clamp and allows the drummer to adjust the length of the toggle clamp's hook to achieve the desired tension required for proper tone on the drum. If further adjustment is required, the drummer merely clamps down on each “hook” on the drum's ring, and repeats the tuning process until the desired tone has been achieved. Due to the simplicity of the design, drum tuning can be achieved within a few minutes' time vs the longer time periods drummers currently experience with tuning drums.

### BRIEF SUMMARY OF THE INVENTION

The drum tuning system is comprised of a ring that is significantly lighter in weight and thinner than rings currently used on drums. Since the ring is thinner it sits lower over the skin of the drum, which results in the drummer having virtually no contact with it while they are playing during a performance. In addition, the part of the system that actually tightens the drum is the toggle clamp that clamps onto “hooks” that are on the sides of the ring. The drummer merely clamps the toggle clamp onto each “hook” on the ring, clamps down on each “hook”, lifts up the handle on the toggle clamp, which in turn loosens the hook on the toggle clamp and allows the drummer to adjust the length of the toggle clamp's hook to achieve the desired tension required for proper tone on the drum.

### DESCRIPTION OF DRAWINGS

FIG. 1 is a front view of the Drum Tuning System;

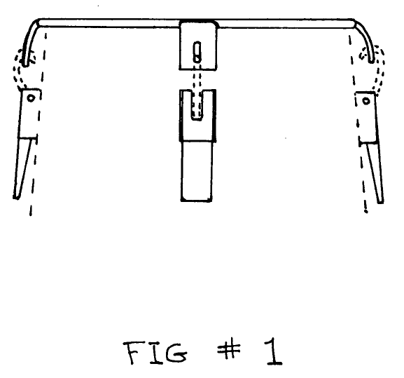

FIG. 2 is a top view of the Drum Tuning System;

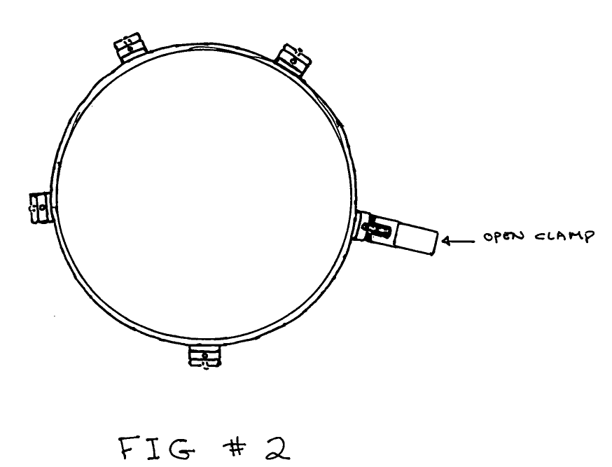

FIG. 3 is a front view of the Drum Tuning System being used with a drum. The side and back views of the Drum Tuning System being used with a drum are identical;

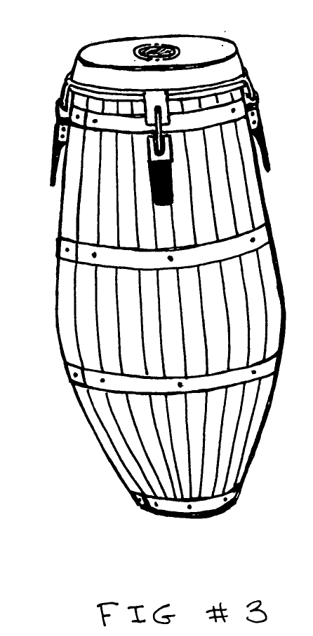

FIG. 4 is top view of the ring portion of the Drum Tuning System;

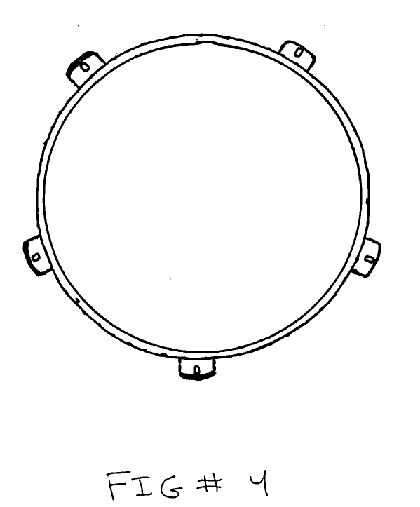

FIG. 5 is a rear view of the ring portion of the Drum Tuning System;

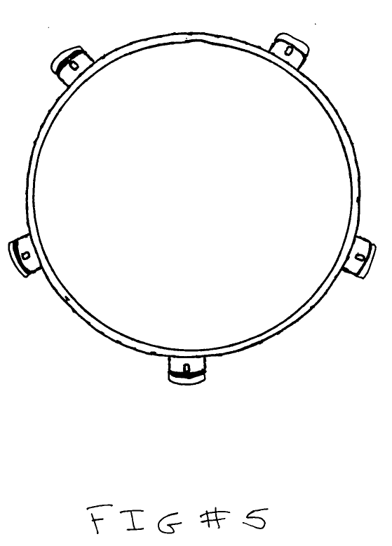

FIG. 6 is a front view of the toggle clamp portion of the Drum Tuning System;

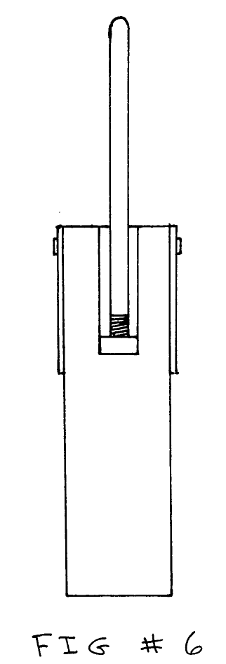

FIG. 7 is a rear view of the toggle clamp portion of the Drum Tuning System;

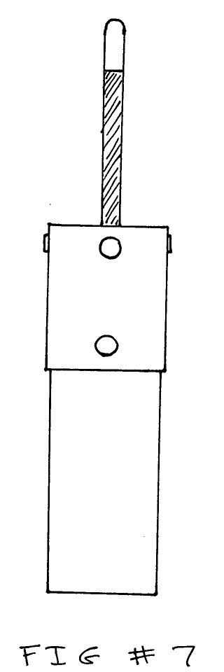

FIG. 8 is side view of the toggle clamp portion of the Drum Tuning System;

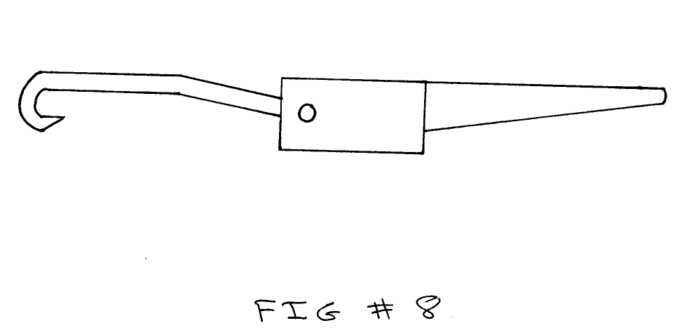

### DETAILED DESCRIPTION OF THE INVENTION

The drum tuning system is comprised of a ring manufactured from materials including but not limited to metal. The ring portion of the drum tuning system is significantly lighter in weight and thinner than those in prior art. Since the ring is thinner, it sits lower over the skin of the drum, which results in the drummer having virtually no contact with it while they are playing during a performance. Therefore, the discomfort drummers experience while playing drums is virtually eliminated. In addition, the part of the system that actually tightens the drum is a toggle clamp that clamps onto “hooks” that are on the sides of the ring. The toggle clamp is made from materials that include but are not limited to metal and the handle of the clamp is covered with materials including but not limited to plastic. The drum tuning system is operated by clamping the toggle clamp onto each “hook” on the system's ring, clamping down on each “hook”, lifting up the handle on the toggle clamp, which in turns loosens the hook on the toggle clamp and allows the drummer to adjust the length of the toggle clamp's hook to achieve the desired tension required for proper tone on the drum. If further adjustment is required, the drummer merely clamps down on each “hook” on the drum's ring, and repeats the tuning process until the desired tone has been achieved.

1. Drum Tuning System comprised of a ring and toggle clamp made of materials including but not limited to metal.

2. Drum Tuning System that decreases the amount of time and effort required to tune drums.

3. Drum Tuning System comprised of a ring that sits lower on drums than conventional drum tuning systems, virtually eliminating the discomfort drummers experience while playing drums.
